(19) United States
(12) Patent Application Publication
(10) Pub. No.: US 2019/0341692 A1
(43) Pub. Date: Nov. 7, 2019

(54) ANTENNA DEVICE AND ELECTRONIC APPLIANCE

(71) Applicant: Murata Manufacturing Co., Ltd., Nagaokakyo-shi (JP)

(72) Inventor: Hiroyuki KUBO, Nagaokakyo-shi (JP)

(21) Appl. No.: 16/513,890

(22) Filed: Jul. 17, 2019

Related U.S. Application Data
(63) Continuation of application No. PCT/JP2018/037830, filed on Oct. 11, 2018.

(30) Foreign Application Priority Data
Oct. 12, 2017 (JP) 2017-198125
Jul. 25, 2018 (JP) 2018-139751

(51) Int. Cl. H01Q 7/06; H01Q 1/36; H01Q 1/22; H02J 7/02; H02J 50/20; H02J 50/10

(52) U.S. Cl. CPC H01Q 7/06; H01Q 1/36; H02J 50/10; H02J 7/025; H02J 50/20; H01Q 1/2283

(57) ABSTRACT

An antenna device includes a magnetic body and first and second antennas. The first coil antenna includes a first opening and is provided on a first main surface side of the magnetic body. The second coil antenna includes a second opening partially superposed with the first opening. The second coil antenna includes first and second coil conductor portions. The first coil conductor portions are provided on the first main surface side of the magnetic body. The second coil conductor portions are provided on a second main surface side of the magnetic body. The second coil conductor portions are closer to the first coil antenna than the first coil conductor portions.

### CROSS REFERENCE TO RELATED APPLICATIONS

This application claims the benefit of priority to Japanese Patent Application No. 2017-198125 filed on Oct. 12, 2017 and Japanese Patent Application No. 2018-139751 filed on Jul. 25, 2018, and is a Continuation Application of PCT Application No. PCT/JP2018/037830 filed on Oct. 11, 2018. The entire contents of each application are hereby incorporated herein by reference.

### BACKGROUND OF THE INVENTION

### 1. Field of the Invention

The present invention relates to an antenna device and an electronic appliance, and more specifically, to an antenna device that includes a plurality of coil antennas and to an electronic appliance including the antenna device.

### 2. Description of the Related Art

An antenna device that includes a plurality of coil antennas is known (for example, refer to International Publication No. 2015/147133).

The antenna device disclosed in International Publication No. 2015/147133 includes a near field communication (NFC) coil, a contactless charging coil, and a magnetic sheet. The main portions of the NFC coil and the contactless charging coil are provided on the upper surface of the magnetic sheet. The contactless charging coil is disposed in a region where an opening of the main portions of the NFC coil extend out of the upper surface of the magnetic sheet in order to reduce the overall size of the antenna device.

In the antenna device disclosed in International Publication No. 2015/147133, the outer peripheral side of a first coil antenna (contactless charging coil) is close to the inner peripheral side of a second coil antenna (NFC coil). Therefore, there is a problem in that the degree of coupling between the first coil antenna and a first partner-side coil antenna, which is a communication partner of the first coil antenna, and the degree of coupling between the second coil antenna and a second partner-side coil antenna, which is a communication partner of the second coil antenna, are reduced. Furthermore, if the second coil antenna is increased in size such that the outer peripheral side of the first coil antenna is no longer close to the inner peripheral side of the second coil antenna, the size of the antenna device as a whole is increased and the manufacturing cost is increased. In addition, conversely, if the first coil antenna is decreased in size such that the outer peripheral side of the first coil antenna is no longer close to the inner peripheral side of the second coil antenna, satisfactory antenna characteristics cannot be secured for the first coil antenna.

### SUMMARY OF THE INVENTION

Preferred embodiments of the present invention provide antenna devices that are each able to improve the degree of coupling between a coil antenna and a partner-side coil antenna for a plurality of coil antennas while being small in size, and provide electronic appliances that each include an antenna device according to a preferred embodiment of the present invention.

An antenna device according to a preferred embodiment of the present invention includes a magnetic body, a first coil antenna, and a second coil antenna. The magnetic body includes a first main surface and a second main surface. The second main surface faces the first main surface. The first coil antenna includes a first opening and is provided on the first main surface side of the magnetic body. The second coil antenna includes a second opening. The first opening is partially superposed with the second opening in a plan view of the first main surface of the magnetic body. The second coil antenna includes a first coil conductor portion and a second coil conductor portion. The first coil conductor portion is provided on the first main surface side of the magnetic body. The second coil conductor portion is provided on the second main surface side of the magnetic body. The second coil conductor portion is closer to the first coil antenna than the first coil conductor portion.

An electronic appliance according to a preferred embodiment of the present invention includes an antenna device according to a preferred embodiment of the present invention and a controller. The controller controls the antenna device.

In each of the antenna devices and the electronic appliances according to preferred embodiments of the present invention, the degree of coupling between a coil antenna and a partner-side coil antenna is able to be improved for a plurality of coil antennas.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a front view of an antenna device according to a preferred embodiment 1 of the present invention.

FIG. 2 is a sectional view taken along line X1-X1 in FIG. 1 of main portions of the antenna device.

FIG. 3 is a perspective view of the antenna device shown in FIG. 1.

FIG. 4 is a schematic view of an electronic appliance according to the preferred embodiment 1 of the present invention.

FIG. 5 is an explanatory drawing for explaining magnetic flux at the time of communication using a first coil antenna of an antenna device according to a preferred embodiment of the present invention.

FIG. 6 is a sectional view taken along line X11-X11 in FIG. 5 of main portions of an antenna device according to a preferred embodiment of the present invention.

FIG. 7 is an explanatory drawing for explaining magnetic flux at the time of communication using a second coil antenna of an antenna device according to a preferred embodiment of the present invention.

FIG. 8 is a sectional view taken along line X12-X12 in FIG. 7 of main portions of an antenna device according to a preferred embodiment of the present invention.

FIG. 9 is a front view of an antenna device according to a preferred embodiment 2 of the present invention.

FIG. 10 is a sectional view taken along line X2-X2 in FIG. 9 of main portions of the antenna device shown in FIG. 9.

FIG. 11 is a perspective view of the antenna device.

FIG. 12 is a front view of an antenna device according to a preferred embodiment 3 of the present invention.

FIG. 13 is a sectional view taken along line X3-X3 in FIG. 12 of main portions of the antenna device shown in FIG. 12.

FIG. 14 is a perspective view of an antenna device according to a preferred embodiment of the present invention.

FIG. 15 is an exploded perspective view of main portions of an antenna device according to a preferred embodiment of the present invention.

FIG. 16 is a front view of an antenna device according to a preferred embodiment 4 of the present invention.

FIG. 17 is an exploded perspective view of main portions of the antenna device shown in FIG. 16.

### DETAILED DESCRIPTION OF THE PREFERRED EMBODIMENTS

Antenna devices and electronic appliances according to preferred embodiments of the present invention will be described with reference to the drawings. The sizes and thicknesses of the elements described in the specification and drawings and the dimensional relationships therebetween are merely illustrative examples, and the elements are not limited to the illustrative examples described in the specification and drawings.

### Preferred Embodiment 1

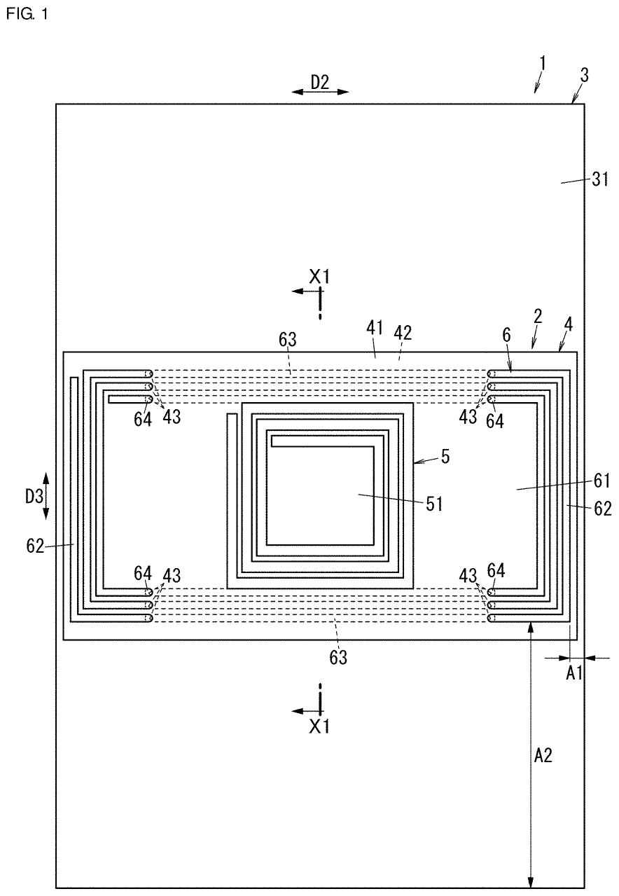

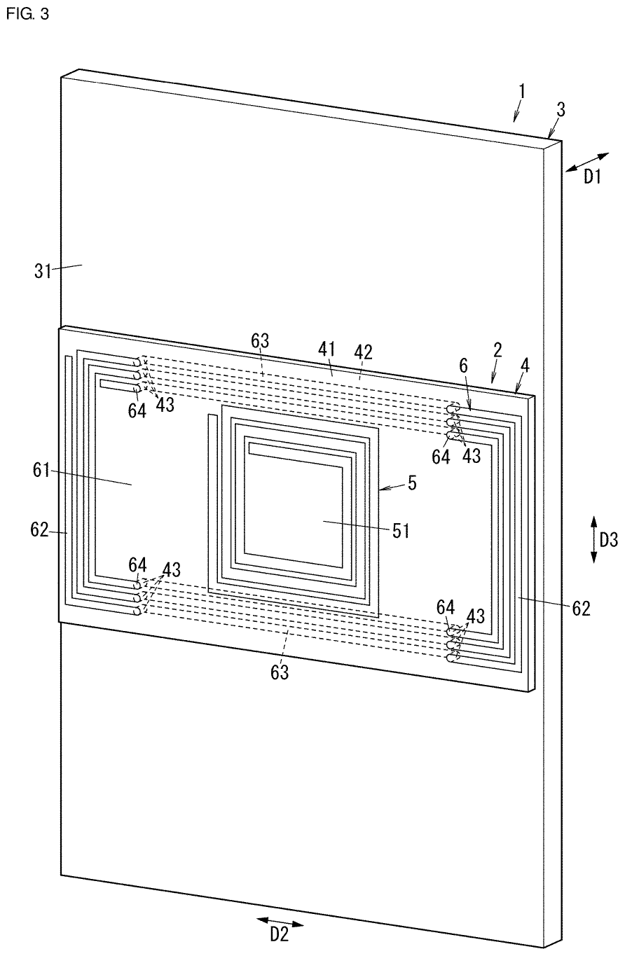

As illustrated in FIGS. 1 to 3, an antenna device 1 according to a preferred embodiment 1 includes an antenna element 2 and a planar conductor 3. The antenna element 2 includes a magnetic body 4, a first coil antenna 5, and a second coil antenna 6. The first coil antenna 5 and the second coil antenna 6 are provided on the magnetic body 4. In addition, a first opening 51 of the first coil antenna 5 is superposed with a second opening 61 of the second coil antenna 6.

In the antenna device 1, the first coil antenna 5 is provided on a first main surface 41 side of the magnetic body 4. First coil conductor portions 62 of the second coil antenna 6 are provided on the first main surface 41 side of the magnetic body 4 and second coil conductor portions 63 of the second coil antenna 6 are provided on a second main surface 42 side of the magnetic body 4. Here, “provided on the first main surface 41 side” indicates an arrangement relationship of being closer to the first main surface 41 than the second main surface 42. “Provided on the second main surface 42 side” indicates an arrangement relationship of being closer to the second main surface 42 than the first main surface 41. Hereafter, “provided on an nth main surface side (n is a natural number)” indicates a similar arrangement relationship.

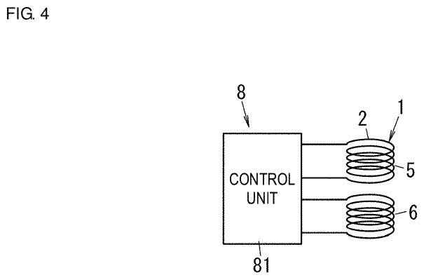

As illustrated in FIG. 4, the antenna device 1 is installed in an electronic appliance 8 and includes a plurality of coil antennas, that is, includes a composite antenna.

The antenna device 1 is used in communication utilizing magnetic field coupling, for example, wireless charging and near field wireless communication (contactless wireless communication). For example, a magnetic field coupling method, such as an electromagnetic induction method or a magnetic resonance method, is an example of a wireless charging method used by the antenna device 1. For example, the “Qi (Registered Trademark)” standard established by the Wireless Power Consortium (WPC) is an example of a wireless charging standard used in an electromagnetic induction method. A frequency band used in an electromagnetic induction method includes frequencies approximately from 110 kHz to 205 kHz, for example. Examples of wireless charging standards used in a magnetic resonance method include the “Rezence (Registered Trademark)” standard established by the Alliance for Wireless Power (A4WP) and the “AirFuel Resonant” standard established by the AirFuel (Registered Trademark) Alliance. A frequency band used in a magnetic resonance method includes frequencies of a 100 kHz band or a 6.78 MHz band, for example. Near field wireless communication used in the antenna device 1 may preferably be near field communication (NFC), for example. A frequency band used in near field wireless communication is for example a HF band, and more specifically the antenna device 1 is preferably used at 13.56 MHz or at a frequency in the vicinity of 13.56 MHz, for example.

In the preferred embodiment 1, preferably, the first coil antenna 5 is a coil antenna for wireless charging and the second coil antenna 6 is a coil antenna for near field wireless communication. For both of the first coil antenna 5 and the second coil antenna 6, the size of the coil antennas is considerably smaller than the wavelengths X corresponding to the frequencies used and the radiation efficiency of electromagnetic waves at the used frequencies is low. The size of the coil antennas is preferably less than or equal to about λ/10, for example. More specifically, the length of a current path of each coil antenna, i.e., the line length of a conductor of the coil antenna as described later is preferably less than or equal to λ/10, for example. The term “wavelength” used herein refers to the effective wavelength which takes into consideration a wavelength shortening effect due to a dielectric property and magnetic permeability of a substrate on which the conductor is provided. Both ends of the conductor of each coil antenna are connected to a respective feeder circuit. A current of uniform or substantially uniform size flows along the current path of the coil antenna, that is, along the conductor of the coil antenna.

The term “communication” is used in a conceptual manner to include both wireless charging and near field wireless communication. In addition, wireless charging may also be referred to as wireless power feeding and wireless power transmission.

The electronic appliance 8 including the antenna device is, for example, a cellular phone such as a smart phone, a wearable device, a wristwatch terminal, headphones, or a hearing aid. The electronic appliance 8 includes a controller 81 in addition to the antenna device 1. The controller 81 controls the antenna device 1. More specifically, for example, the controller 81 includes a wireless charging IC that performs control such that the first coil antenna 5 performs wireless charging and a near field wireless communication IC that performs control such that the second coil antenna 6 performs near field wireless communication.

Next, the elements of the antenna device 1 according to the preferred embodiment 1 will be described while referring to the drawings.

As illustrated in FIGS. 1 to 3, for example, the planar conductor 3 is preferably made, for example, of a metal or the like so as to have a plate shape including rectangular or substantially rectangular main surfaces. The planar conductor 3 is preferably, for example, made of a material such as aluminum, stainless steel, copper, or the like. The planar conductor 3 is preferably, for example, a metal case of a secondary battery provided inside the electronic appliance 8 (refer to FIG. 4). The planar conductor 3 includes a main surface 31 and the main surface 31 faces the antenna element 2 in a first direction D1 (the first direction D1 is a direction in which the main surface 31 of the planar conductor 3 is viewed in a plan view or a direction that is perpendicular or substantially perpendicular to the main surface 31 of the planar conductor 3 or a thickness direction of the planar conductor 3 or a direction in which the first main surface 41 or second main surface 42 of the magnetic body 4 is viewed in a plan view or a direction that is perpendicular or substantially perpendicular to the first main surface 41 or second main surface of the magnetic body 4 or the thickness direction of the magnetic body 4). In other words, the planar conductor 3 is arranged so as to be at least partially superposed with the antenna element 2 in a plan view of the main surface 31 of the planar conductor 3. In more detail, the planar conductor 3 is provided on the second main surface 42 side of the magnetic body 4 in the first direction D1. In other words, the planar conductor 3 is located closer to the second main surface 42 of the magnetic body 4 than the first main surface 41 of the magnetic body 4 in the first direction D1. The main surface 31 is preferably, for example, a rectangular or substantially rectangular planar surface.

For the planar conductor 3, a dimensional ratio of the dimension in a second direction D2 or a third direction D3 with respect to the dimension in the first direction D1 is greater than 1. That is, the planar conductor 3 has a larger dimension in the second direction D2 than in the first direction D1. The second direction D2 and the third direction D3 are directions that are perpendicular or substantially perpendicular to the first direction D1. In other words, the second direction D2 and the third direction D3 are directions that extend along the main surface 31 of the planar conductor 3. Furthermore, the third direction D3 is perpendicular or substantially perpendicular to the second direction D2. In the present preferred embodiment, the planar conductor 3 preferably has a rectangular or substantially rectangular outer shape in a plan view of the magnetic body 4, for example, the second direction D2 extends along a direction in which the short edges of the outer shape of the planar conductor 3 extend, and the third direction D3 extends along the direction in which the long edges of the planar conductor 3 extend.

The main surface 31 of the planar conductor 3 that faces the antenna element 2 does not have to be completely planar. Here, the main surface 31 may be referred to as being planar even when the main surface 31 has irregularities that are small compared with the dimension of the planar conductor 3 in the first direction D1 (thickness of planar conductor 3) or the dimension of the planar conductor 3 in the second direction D2. In addition, the entirety of the main surface 31 does not have to be planar. That is, at least a portion of the main surface 31 may be planar.

As illustrated in FIGS. 1 to 3, the antenna element 2 has a plate shape including rectangular or substantially rectangular main surfaces, and includes the magnetic body 4, the first coil antenna 5, and the second coil antenna 6. In addition, although not illustrated, the antenna element 2 may additionally include a protective layer on the surface of the conductors of the first coil antenna 5 and the second coil antenna 6 such that the conductors are not exposed. The antenna element 2 is adjacent to (close to) the planar conductor 3 in the first direction D1. The antenna element 2 may be almost attached to the planar conductor 3 such that insulation is provided between the second coil antenna and the planar conductor 3 or the antenna element 2 may be arranged such that there is a gap between the antenna element 2 and the planar conductor 3.

The magnetic body 4 has a rectangular or substantially plate shape or a rectangular or substantially rectangular sheet shape, and includes the first main surface 41 and the second main surface 42. The magnetic body 4 is preferably made of a ferromagnetic material, such as ferrite, for example. For example, the magnetic body 4 is preferably made of a sintered ferrite or an amorphous magnetic material. For example, a Mn—Zn—Fe ferrite or Ni—Zn—Fe ferrite may preferably be used as the ferromagnetic material used in the magnetic body 4. The magnetic body 4 has higher magnetic permeability than the planar conductor 3 and the protective layer (not illustrated). The first main surface 41 of the magnetic body 4 and the second main surface 42 of the magnetic body 4 are opposite surfaces in the first direction D1.

In addition, the magnetic body 4 includes a plurality (twelve in the illustrated example) of through holes 43. The through holes 43 are provided in portions of a region of the magnetic body 4 where the second coil antenna 6 is provided. The through holes 43 penetrate between the first main surface 41 and the second main surface 42 of the magnetic body 4.

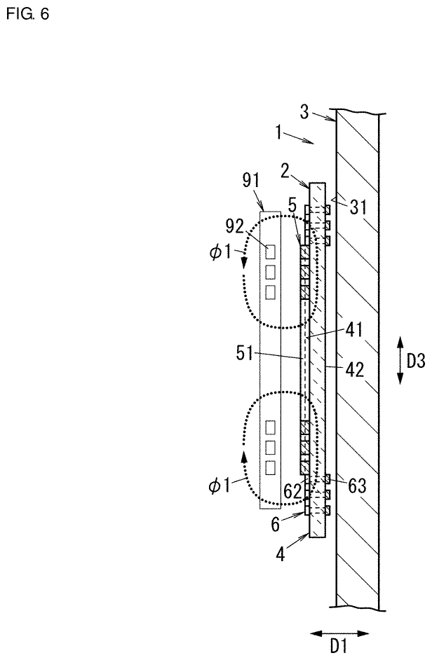

The first coil antenna 5 preferably has, for example, a square annular shape in a plan view from the first direction D1, and includes a first opening 51. The first coil antenna 5 communicates in a first frequency band with a first partner-side coil antenna 92 (refer to FIG. 6), which is a communication partner of the first coil antenna 5. The first partner-side coil antenna 92 is provided in a first partner-side antenna device 91.

The first coil antenna 5 is provided on the first main surface 41 side of the magnetic body 4. In other words, the first coil antenna 5 is closer to the first main surface 41 of the magnetic body 4 than the second main surface 42 of the magnetic body 4 in the first direction D1. In more detail, the first coil antenna 5 is provided on the first main surface 41 of the magnetic body 4. Here, “provided on the first main surface 41” indicates an arrangement relationship of being closer to the first main surface 41 than the second main surface 42 in the first direction D1 and being superposed with the first main surface 41 in a plan view of the first main surface 41. Hereafter, “provided on an nth main surface (n is a natural number)” indicates a similar arrangement relationship.

The first coil antenna 5 includes a long thin line-shaped conductor, is provided in a spiral shape around a first axis that extends along the first direction D1, and defines the first opening 51, which is a coil opening of the first coil antenna 5. In more detail, the first coil antenna 5 is provided such that the conductor thereof is wound through a plurality of turns around the first axis in a plan view from the first axis direction (first direction D1). For example, the first coil antenna 5 is preferably provided such that the conductor is wound through about three turns. The first coil antenna 5 is preferably made of, for example, copper, aluminum, or the like, and is provided on the first main surface side of the magnetic body 4. For example, the first coil antenna 5 is provided on the first main surface 41 side of the magnetic body 4 by providing a copper film or an aluminum film on the first main surface 41 of the magnetic body 4 by performing etching or printing.

Here, regarding the first coil antenna 5, “provided so as to be wound through N (N is a natural number) turns” includes not only the case where a line-shaped conductor is wound through N turns but also a case where a pattern is formed in the shape of a line-shaped conductor wound through N turns.

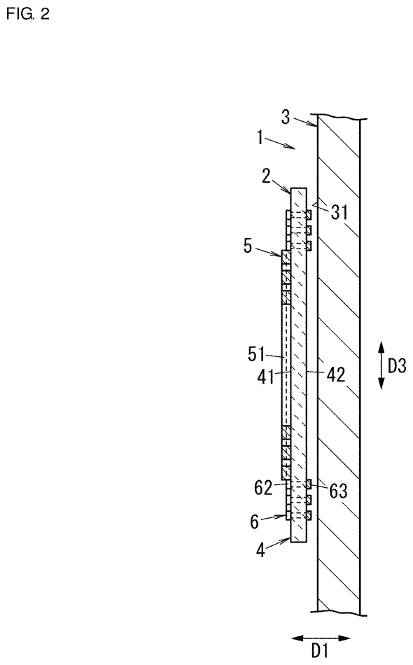

Furthermore, the first coil antenna 5 provided in a spiral shape may be a two-dimensional coil antenna having a shape in which the conductor is wound through a plurality of turns in a spiral shape around a winding axis on a single plane. Alternatively, the first coil antenna 5 provided in a spiral shape may be a three-dimensional coil antenna having a shape in which the conductor is wound through a plurality of turns around a winding axis in a helical shape along the winding axis. FIGS. 1 and 2 illustrate a two-dimensional coil antenna.

In the first coil antenna 5, the conductor line width is preferably the same or substantially the same at all positions between the innermost periphery of the first coil antenna 5 and the outermost periphery of the first coil antenna 5. However, there may instead be different conductor line widths between the innermost periphery of the first coil antenna 5 and the outermost periphery of the first coil antenna 5. In the case where the first coil antenna 5 has a shape in which the conductor is wound in a spiral shape around the first axis, the conductor line width of the first coil antenna 5 refers to the length of the line-shaped conductor defining the first coil antenna 5 in a lateral direction that is perpendicular or substantially perpendicular to the longitudinal direction (extension direction) of the line-shaped conductor.

In the first coil antenna 5, the conductor line width is preferably larger than an inter-line width between two adjacent conductors.

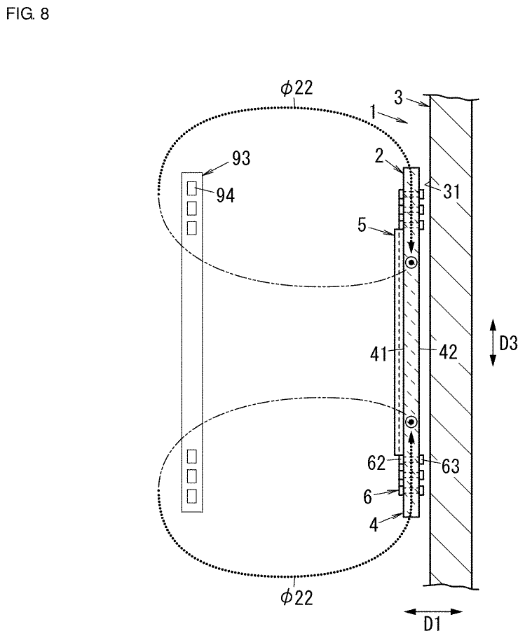

The second coil antenna 6 preferably has, for example, a rectangular or substantially rectangular annular shape in a plan view from the first direction D1, and includes the second opening 61. The second coil antenna 6 is provided around the periphery of the first coil antenna 5. That is, the second coil antenna 6 is provided outside the outermost periphery of the first coil antenna 5. The second coil antenna 6 communicates in a second frequency band with a second partner-side coil antenna 94 (refer to FIG. 8), which is a communication partner of the second coil antenna 6. The second frequency band is different from the first frequency band. The second partner-side coil antenna 94 is provided in a second partner-side antenna device 93.

The second coil antenna 6 includes a long thin line-shaped conductor, is provided in a spiral shape around a second axis that extends along the first direction D1 of the magnetic body 4, and defines the second opening 61, which is a coil opening of the second coil antenna 6. In more detail, the second coil antenna 6 is provided such that the conductor thereof is wound through a plurality of turns around the second axis in a plan view from the second axis direction (first direction D1). For example, the second coil antenna 6 is preferably provided such that the conductor is wound through about three turns. The second coil antenna 6 is preferably made of copper, aluminum, or the like, and is provided on the magnetic body 4. For example, the second coil antenna 6 is provided on the first main surface 41 side of the magnetic body 4 by providing a copper film or an aluminum film on the magnetic body 4 by performing etching or printing.

Here, also in the case of the second coil antenna 6, similarly to the first coil antenna 5, “provided so as to be wound through N (N is a natural number) turns” includes not only the case where a line-shaped conductor is wound through N turns, but also a case where a pattern is provided in the shape of a line-shaped conductor wound through N turns.

Furthermore, the second coil antenna 6 provided in a spiral shape may be a two-dimensional coil antenna having a shape in which the conductor is wound through a plurality of turns in a spiral shape around a winding axis on a single plane. Alternatively, the second coil antenna 6 provided in a spiral shape may be a three-dimensional coil antenna having a shape in which the conductor is wound through a plurality of turns around a winding axis in a helical shape along the winding axis. FIGS. 1 and 2 illustrate a two-dimensional coil antenna.

In the second coil antenna 6, the conductor line width is preferably the same or substantially the same at all positions between the innermost periphery of the second coil antenna 6 and the outermost periphery of the second coil antenna 6. However, there may instead be different conductor line widths between the innermost periphery of the second coil antenna 6 and the outermost periphery of the second coil antenna 6. In the case where the second coil antenna 6 has a shape in which the conductor is wound in a spiral shape around the second axis, the conductor line width of the second coil antenna 6 refers to the length of the line-shaped conductor constituting the second coil antenna 6 in a lateral direction that is perpendicular to the longitudinal direction (extension direction) of the line-shaped conductor.

In the second coil antenna 6, the conductor line width is preferably larger than an inter-line width between two adjacent conductors.

Regarding the first coil antenna 5 and second coil antenna 6, the first opening 51 of the first coil antenna 5 and the second opening 61 of the second coil antenna 6 are superposed with each other in a plan view from the first direction D1. In other words, the first opening 51 and the second opening 61 are superposed with each other in a plan view from the first main surface 41 or the second main surface 42 of the magnetic body 4.

The first coil antenna 5 is provided on the first main surface 41 side of the magnetic body 4. In more detail, the first coil antenna 5 is provided in a center portion on the first main surface 41 of the magnetic body 4.

The second coil antenna 6 includes two first coil conductor portions 62, two second coil conductor portions 63, and four connection portions 64. The second coil antenna 6 is provided in a region of the magnetic body 4 that is closer to the outer periphery of the magnetic body 4 than the first coil antenna 5. Each first coil conductor portion 62 includes a plurality of first conductor portions (three in the illustrated example). Each second coil conductor portion 63 includes a plurality of second conductor portions (three in the illustrated example). The second coil antenna 6 is provided around the periphery of the first coil antenna 5 in a plan view from the first direction D1.

The two second coil conductor portions 63 are closer to the first coil antenna 5 than the two first coil conductor portions 62. In more detail, the distance between each second coil conductor portion 63 and the first coil antenna 5 is smaller than the distance between each first coil conductor portion 62 and the first coil antenna 5. Here, the distance between each second coil conductor portion 63 and the first coil antenna 5 refers to the shortest distance in a three-dimensional space between the center point of a line-shaped conductor defining the second coil conductor portion 63 and the first coil antenna 5. Similarly, the distance between each first coil conductor portion 62 and the first coil antenna 5 refers to the shortest distance in a three-dimensional space between the center point of a line-shaped conductor constituting the first coil conductor portion 62 and the first coil antenna 5.

Furthermore, the two second coil conductor portions 63 are closer to the first coil antenna 5 than the two first coil conductor portions 62 in a direction parallel or substantially parallel to the first main surface 41 (direction perpendicular or substantially perpendicular to first direction D1) in a plan view of the first main surface 41 of the magnetic body 4. In more detail, the distance between each second coil conductor portion 63 and the first coil antenna 5 in a direction parallel or substantially parallel to the first main surface 41 (third direction D3) is smaller than the distance between each first coil conductor portion 62 and the first coil antenna 5 in a direction parallel or substantially parallel to the first main surface 41 (second direction D2) in a plan view of the first main surface 41 of the magnetic body 4.

The two first coil conductor portions 62 are provided on the first main surface 41 side of the magnetic body 4. In more detail, the two first coil conductor portions 62 are provided at both end portions of the first main surface 41 of the magnetic body 4 in the second direction D2 (the direction in which the short edges of the planar conductor 3 extend or the direction in which the long edges of magnetic body 4 extend). The main portion of each first coil conductor portion 62 extends along the outer edge of the magnetic body 4 that extends in the third direction D3 (the direction in which the long edges of the planar conductor 3 extend or the direction in which the short edges of the magnetic body 4 extend).

The two second coil conductor portions 63 are provided on the second main surface 42 side of the magnetic body 4. In more detail, the two second coil conductor portions 63 are provided at both end portions of the second main surface 42 of the magnetic body 4 in the third direction D3. The second coil conductor portions 63 are provided so as to extend in the second direction D2 and are provided along the outer edges of the magnetic body 4.

The four connection portions 64 are respectively provided between the first coil conductor portions 62 and the second coil conductor portions 63 in the magnetic body 4. The connection portions 64 are conductors that are provided in the through holes 43 of the magnetic body 4. The first coil conductor portions 62 and the second coil conductor portions 63 are not superposed with each other in the first direction D1.

The two first coil conductor portions 62 and the two second coil conductor portions 63 are integrated with the four connection portions 64 and a spiral-shaped coil that defines the second opening 61, which is a single coil opening, is provided by the two first coil conductor portions 62, the two second coil conductor portions 63, and the four connection portions 64. In other words, the plurality of first conductor portions defining the first coil conductor portions 62 and the plurality of second conductor portions defining the second coil conductor portions 63 are connected to each other. In addition, the first coil conductor portions 62 and the second coil conductor portions 63 are provided at positions so as not to be superposed with each other in a plan view from the first direction D1 except for at the locations of the connection portions 64. In addition, the first coil conductor portions 62 and the second coil conductor portions 63 are provided at positions so as not to be superposed with each other in a plan view of the magnetic body 4 except for at the locations of the connection portions 64. In other words, a first coil conductor region defined by the plurality of first conductor portions defining the first coil conductor portions 62 and a second coil conductor region defined by the plurality of second conductor portions defining the second coil conductor portions 63 are not superposed with each other in a plan view of the magnetic body 4 except for at the locations of the connection portions 64.

The first coil conductor portions 62 are closer to the outer edge of the planar conductor 3 than the second coil conductor portions 63. In more detail, a distance Al between the outermost periphery of the first coil conductor portions 62 and the outer edges of the planar conductor 3 extending in the third direction D3 is smaller than a distance A2 between the second coil conductor portions 63 and the outer edges of the planar conductor 3 extending in the second direction D2. The relationship between the distances also holds true in the case of directions parallel or substantially parallel to the first main surface 41 of the magnetic body 4.

Furthermore, since the first main surface 41 of the magnetic body 4, the second main surface 42 of the magnetic body 4, and the main surface 31 of the planar conductor 3 are parallel or substantially parallel to each other, directions that are parallel or substantially parallel to the first main surface 41 of the magnetic body 4 may be also said to be directions that are parallel or substantially parallel to the other surfaces.

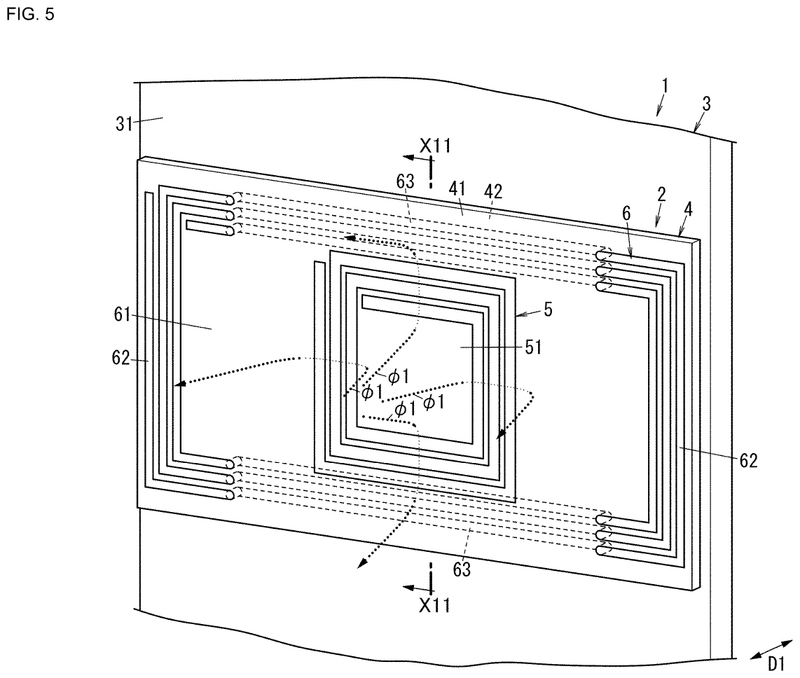

Next, magnetic flux in the antenna device 1 according to the preferred embodiment 1 will be described while referring to FIGS. 5 to 8.

First, magnetic flux at the time of communication using the first coil antenna 5 will be described while referring to FIGS. 5 and 6.

In the first direction D1, magnetic flux φ1 from the first partner-side coil antenna 92, which is the communication partner of the first coil antenna 5 and is positioned on the opposite side of the first coil antenna 5 from the side where the magnetic body 4 is disposed, enters the inside of the magnetic body 4 via the first opening 51 of the first coil antenna 5. The magnetic flux φ1 that has entered the inside of the magnetic body 4 flows toward the region where the outermost periphery of the first coil antenna 5 is provided. Then, the magnetic flux φ1 exits to outside the magnetic body 4 from a region that is outside the outermost periphery of the first coil antenna 5 and thus links with the first coil antenna 5. Here, the second coil conductor portions 63 of the second coil antenna 6, which are close to the first coil antenna 5, are provided on the second main surface 42 side of the magnetic body 4. Therefore, the magnetic flux φ1 that is linked to the first coil antenna 5 is not obstructed.

As described above, even in the case of a configuration where the first coil antenna 5 includes portions that are close to the second coil antenna 6, the magnetic flux φ1 from the first partner-side coil antenna 92 flows around the periphery of the first coil antenna 5 without receiving interference from the second coil antenna 6. Thus, the degree of coupling between the first coil antenna 5 and the first partner-side coil antenna 92 is able to be increased. As a result, in the case where the first coil antenna 5 is for wireless charging, the charging efficiency is able to be increased.

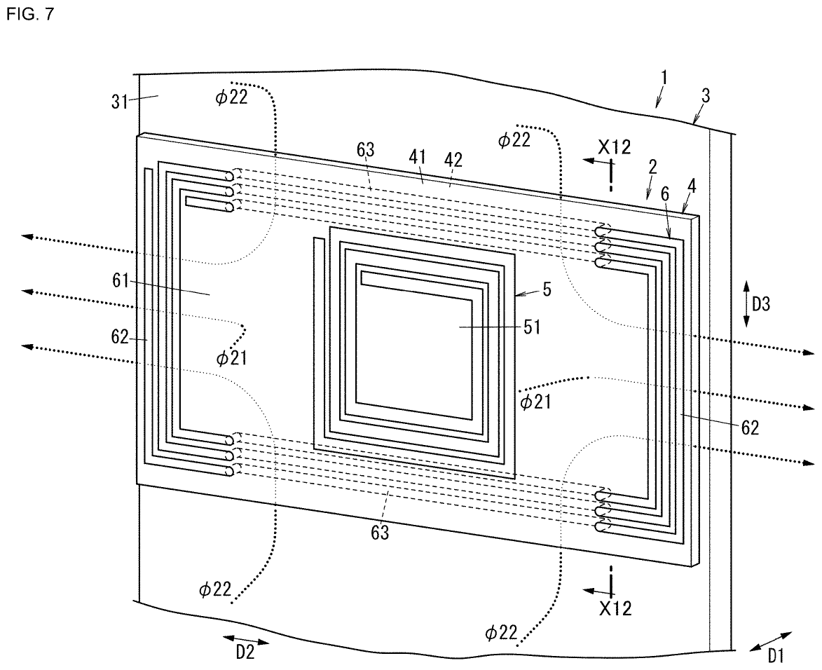

Next, magnetic flux at the time of communication using the second coil antenna 6 will be described while referring to FIGS. 7 and 8.

In the first direction D1, magnetic flux φ21 from the second partner-side coil antenna 94, which is the communication partner of the second coil antenna 6, enters the inside of the magnetic body 4 via the second opening 61 of the second coil antenna 6. The magnetic flux φ21 that has entered the inside of the magnetic body 4 flows toward the portions where the first coil conductor portions 62 of the second coil antenna 6 are provided in the second direction D2. Then, the magnetic flux φ1 exits to outside the magnetic body 4 from an outer edge of the magnetic body 4 that is outside the outermost periphery of the second coil antenna 6 and thus links with the second coil antenna 6. The magnetic flux φ21 of the second partner-side coil antenna 94 flows around the periphery of the second coil antenna 6 and interference from the first coil antenna 5 is reduced.

When magnetic flux φ22 from the second partner-side coil antenna 94 advances toward the planar conductor 3 in the first direction D1, the magnetic flux φ22 flows toward the magnetic body 4 and enters the inside of the magnetic body 4. The magnetic flux φ22 that has entered the inside of the magnetic body flows toward the portions where the first coil conductor portions 62 of the second coil antenna 6 are arranged in the second direction D2. Then, the magnetic flux φ22 exits to outside the magnetic body 4 from an outer edge of the magnetic body 4 that is outside the outermost periphery of the second coil antenna 6 and thus links with the second coil antenna 6. As in the case of the magnetic flux φ21, the magnetic flux φ22 from the second partner-side coil antenna 94 flows around the periphery of the second coil antenna 6 and interference from the first coil antenna 5 is reduced. On the other hand, if the entirety or substantially the entirety of the second coil antenna were provided on the first main surface 41 side of the magnetic body 4, when the magnetic flux φ22 from the second partner-side coil antenna 94 advances toward the planar conductor 3 in the first direction D1, the magnetic flux would not follow the above-described path and would not link with the second coil antenna 6.

As described above, in a plan view from the first direction D1, not only the magnetic flux φ21 incident to the region of the second opening 61 but also the magnetic flux φ22 incident outside the second opening 61 are able to be collected. Thus, the effective antenna size is able to be increased. As a result, in the case where the second coil antenna 6 is for near field wireless communication, the communication performance is able to be further increased. This effect is able to be further strengthened as a result of the first coil conductor portions 62 being closer to the outer edge of the planar conductor 3 than the second coil conductor portions 63.

As described above, in the antenna device 1 according to the preferred embodiment 1, the first coil antenna 5 and the first coil conductor portions 62 of the second coil antenna 6 are provided on the first main surface 41 side of the magnetic body 4, and the second coil conductor portions 63 of the second coil antenna 6, which are provided closer to the first coil antenna 5 than the first coil conductor portions 62 of the second coil antenna 6, are provided on the second main surface 42 side of the magnetic body 4. Thus, even in the case of a configuration where the first coil antenna 5 includes portions that are close to the second coil antenna 6, interference arising from the second coil antenna 6 in communication between the first coil antenna 5 and the first partner-side coil antenna 92 is able to be reduced, and therefore the degree of coupling between the first coil antenna 5 and the first partner-side coil antenna 92 is able to be improved. Furthermore, interference arising from the first coil antenna 5 in communication between the second coil antenna 6 and the second partner-side coil antenna 94 is also able to be reduced, and therefore the degree of coupling between the second coil antenna 6 and the second partner-side coil antenna 94 is also able to be improved.

In the antenna device 1 according to the preferred embodiment 1, the planar conductor 3 is provided on the second main surface 42 side of the magnetic body 4. It is difficult for magnetic flux to flow through the planar conductor 3, and therefore the magnetic fluxes φ1, φ21, and φ22 flowing in a direction perpendicular or substantially perpendicular to the first main surface 41 or the second main surface 42 of the magnetic body 4 are able to be easily changed to flow in a direction that intersects that direction. As a result, collection of magnetism is able to be improved.

In the antenna device 1 according to the preferred embodiment 1, the first coil conductor portions 62 are closer to the outer edge of the planar conductor 3 than the second coil conductor portions 63. Consequently, magnetic resistance is lower in the direction in which the first coil conductor portions 62 face each other in a planar direction of the planar conductor 3 than in a direction in which the second coil conductor portions 63 face each other. As a result, the magnetic flux φ21 that flows through the second opening 61 of the second coil antenna 6 from the first main surface 41 side of the magnetic body 4 is able to flow inside the magnetic body 4 toward the sides where the first coil conductor portions 62 are disposed and return to the second partner-side coil antenna 94. Furthermore, the magnetic flux φ22 flowing along the planar conductor 3 is able to enter the inside of the magnetic body 4 from the portions where the second coil conductor portions 63 are disposed, flow inside the magnetic body 4 toward the sides where the first coil conductor portions 62 are disposed, and return to the second partner-side coil antenna 94.

Furthermore, in the antenna device 1 according to the preferred embodiment 1, the first coil antenna 5 and the second coil antenna 6 are directly provided on the magnetic body 4. Consequently, since there is no need to provide a separate substrate from the magnetic body 4 in order to install the first coil antenna 5 and the second coil antenna 6, the thickness of the antenna element 2 in the first direction D1 is able to be reduced.

Hereafter, modifications of the preferred embodiment 1 will be described.

In the antenna device 1, the first coil antenna 5 may be a coil antenna for near field wireless communication and the second coil antenna 6 may be a coil antenna for wireless charging.

Furthermore, the application of the antenna device 1 is not limited to the combination of wireless charging and near field wireless communication. The antenna device 1 may be used for wireless charging according to a plurality of different standards. In this case, the first coil antenna 5 and the second coil antenna 6 would be coil antennas for wireless charging according to a plurality of different standards. For example, the first coil antenna 5 may be a Qi coil antenna and the second coil antenna 6 may be an A4WP coil antenna.

Alternatively, the antenna device 1 may be used for a combination of near field wireless communication according to a plurality of different standards. In this case, the first coil antenna 5 and the second coil antenna 6 would be coil antennas for near field wireless communication according to a plurality of different standards.

The planar conductor 3 is not limited to being the metal case of a secondary battery, and may instead be, for example, a metal portion of the casing of the electronic appliance 8 (refer to FIG. 4) or may be any of various metal members, such as a ground conductor of a printed circuit board installed inside the electronic appliance 8, a shield box, or a back metal member of a display.

In addition, the planar conductor 3 is not limited to being arranged to face the entirety or substantially the entirety of the antenna element 2 in the first direction D1. For example, the planar conductor 3 may be arranged to face only the first coil antenna 5 in the first direction D1. As another example, the planar conductor 3 may be arranged to face only the second coil antenna 6 in the first direction D1. In short, it is sufficient that the planar conductor 3 is arranged to be close to at least a portion of the antenna element 2 in the first direction D1.

Furthermore, as a modification of the preferred embodiment 1, the antenna device 1 does not have to include the planar conductor 3. That is, the planar conductor 3 is not an essential element.

The shape of the antenna element 2 is not limited to a rectangular or substantially rectangular shape. The antenna element 2 may have a quadrangular or substantially quadrangular shape other than a rectangular or substantially rectangular shape, such as a square or substantially square shape in a plan view from the first direction D1. Alternatively, the antenna element 2 may have a circular or substantially circular shape or may have a polygonal or substantially polygonal shape other than a quadrangular or substantially quadrangular shape in a plan view from the first direction D1.

The size of the first opening 51 of the first coil antenna 5 is not restricted. Similarly, the size of the second opening 61 of the second coil antenna 6 is not restricted.

The first coil antenna 5 is not limited to having a one-layer structure as illustrated in FIG. 2 and may instead have a structure including two or more layers. Similarly, the second coil antenna 6 is not limited to having a one-layer structure as illustrated in FIG. 2 and may instead have a structure including two or more layers.

Furthermore, the number of loops (number of turns) of the first coil antenna 5 is not limited to about three. The first coil antenna 5 may be provided such that the conductor is wound through about two turns or less, or may be provided such that the conductor is wound through about four or more turns. Similarly, the number of loops (number of turns) of the second coil antenna 6 is not limited to about three. The second coil antenna 6 may be provided such that the conductor is wound through about two turns or less, or may be provided such that the conductor is wound through about four or more turns.

The antenna device 1 according to each of the above-described modifications also provides similar advantageous effects to the antenna device 1 according to preferred embodiment 1.

### Preferred Embodiment 2

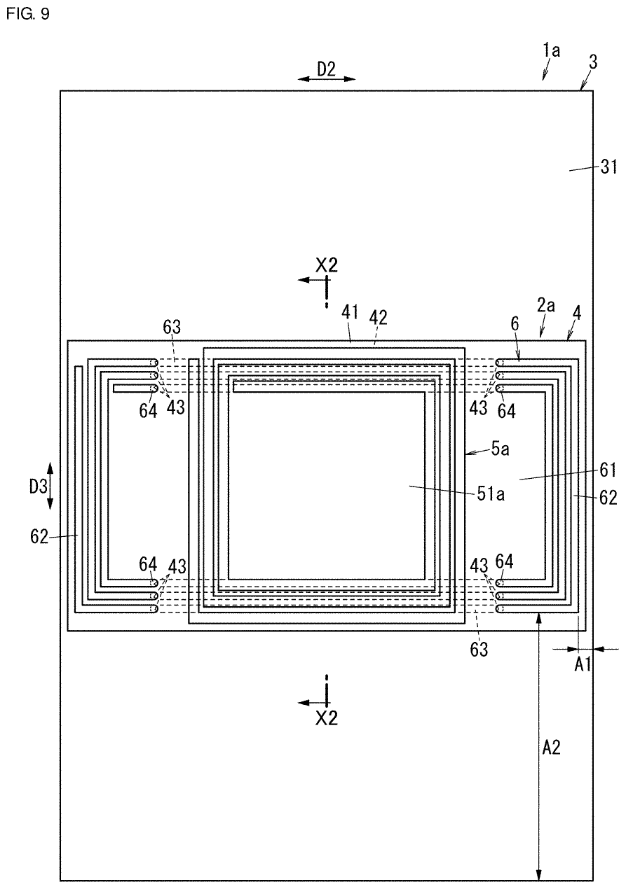

As illustrated in FIG. 9, an antenna device 1a according to a preferred embodiment 2 of the present invention differs from the antenna device 1 according to the preferred embodiment 1 (refer to FIG. 1) in that portions of a first coil antenna 5a are superposed with second coil conductor portions 63 of a second coil antenna 6. Elements that are the same or substantially the same as those of the antenna device 1 according to the preferred embodiment 1 are denoted by the same symbols and description thereof is omitted.

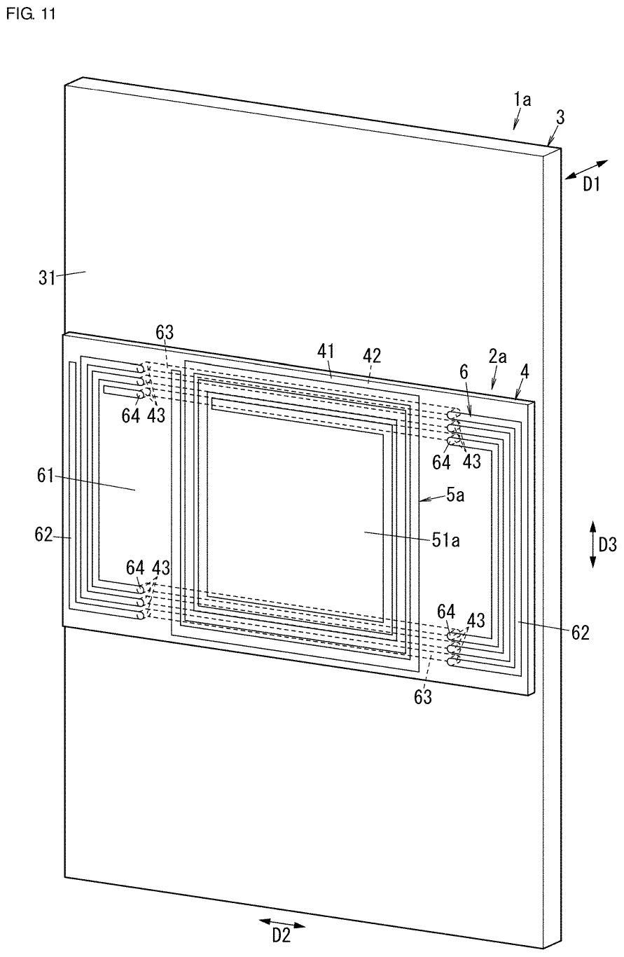

As illustrated in FIGS. 9 to 11, the antenna device 1a according to the preferred em 2 includes an antenna element 2a and a planar conductor 3. The planar conductor 3 of the preferred em 2 has the same or substantially shape and function as the planar conductor 3 of preferred em 1.

The antenna element 2a preferably a rectangular or substantially rectangular shape, for example, and includes a magnetic body 4 and a second coil antenna 6 similarly to the antenna element 2 of preferred em 1 (refer to FIG. 1). In addition, the antenna element 2a further includes the first coil antenna 5a instead of the first coil antenna 5 (refer to FIG. 1). Description of configurations and functions that are the same as in the antenna element 2 of the preferred em 1 is omitted.

The first coil antenna 5a preferably has a square or substantially square annular shape in a plan view from the first direction D1, and includes a first opening 51a. The first coil antenna 5a communicates in a first frequency band with a first partner-side coil antenna 92 (refer to FIG. 6), which is a communication partner of the first coil antenna 5a, similarly to the first coil antenna 5 of preferred embodiment 1.

The first coil antenna 5a is provided on the first main surface 41 side of the magnetic body 4. In more detail, the first coil antenna 5a is provided on the first main surface 41 of the magnetic body 4. In other words, the first coil antenna 5a is closer to the first main surface 41 of the magnetic body 4 than the second main surface 42 of the magnetic body 4 in the first direction D1.

The first coil antenna 5a of the preferred em 2 is larger than the first coil antenna 5 of the preferred embodiment 1. The first coil antenna 5a is provided on the first main surface 41 side of the magnetic body 4 such that portions of the first coil antenna 5a are superposed with second coil conductor portions 63 of the second coil antenna 6 in a plan view from the first direction D1. In other words, the first coil antenna 5a is configured such that the entirety or substantially the entirety of the first coil antenna 5a is not superposed with the second opening 61 of the second coil antenna 6 in a plan view from the first direction D1.

Furthermore, in the second coil antenna 6 of the preferred embodiment 2, the two second coil conductor portions 63 are closer to the first coil antenna 5a than the two first coil conductor portions 62, similarly to as in the preferred embodiment 1. In more detail, the distance between each second coil conductor portion 63 and the first coil antenna 5a is smaller than the distance between each first coil conductor portion 62 and the first coil antenna 5a. Here, the distance between each second coil conductor portion 63 and the first coil antenna 5a refers to the shortest distance in a three-dimensional space. Similarly, the distance between each first coil conductor portion 62 and the first coil antenna 5a refers to the shortest distance in a three-dimensional space.

As described above, in the antenna device 1a according to the preferred embodiment 2 as well, the first coil antenna 5a and the first coil conductor portions 62 of the second coil antenna 6 are provided on the first main surface 41 side of the magnetic body 4, and the second coil conductor portions 63 of the second coil antenna 6, which are closer to the first coil antenna 5a than the first coil conductor portions 62 of the second coil antenna 6, are provided on the second main surface 42 side of the magnetic body 4, similarly to as in the antenna device 1 according to the preferred embodiment 1 (refer to FIG. 1). Consequently, interference caused by the second coil antenna 6 in communication between the first coil antenna 5a and the first partner-side coil antenna 92 (refer to FIG. 6) is able to be reduced, and therefore, the degree of coupling between the first coil antenna 5a and the first partner-side coil antenna 92 is able to be improved. In addition, interference caused by the first coil antenna 5a in communication between the second coil antenna 6 and the second partner-side coil antenna 94 (refer to FIG. 8) is able to also be reduced, and therefore, the degree of coupling between the second coil antenna 6 and the second partner-side coil antenna 94 is also able to be improved.

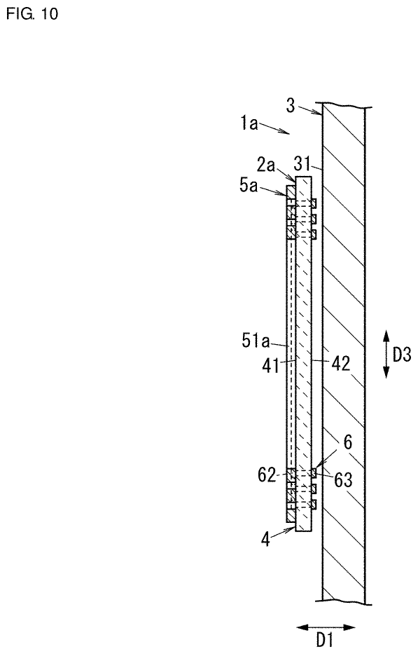

In addition, similarly to the first coil antenna 5 of the preferred embodiment 1, the first coil antenna 5a of the preferred embodiment 2 may be a two-dimensional coil antenna having a shape in which the conductor is wound through a plurality of turns in a spiral shape around a winding axis on a single plane. Alternatively, the first coil antenna 5a provided in a spiral shape may be a three-dimensional coil antenna having a shape in which the conductor is wound through a plurality of turns around a winding axis in a helical shape along the winding axis. FIGS. 9 and 10 illustrate a two-dimensional coil antenna.

Furthermore, the antenna device 1a according to the preferred embodiment 2 is used by being mounted in the electronic appliance 8 (refer to FIG. 4) similarly to the antenna device 1 according to the preferred embodiment 1.

### Preferred Embodiment 3

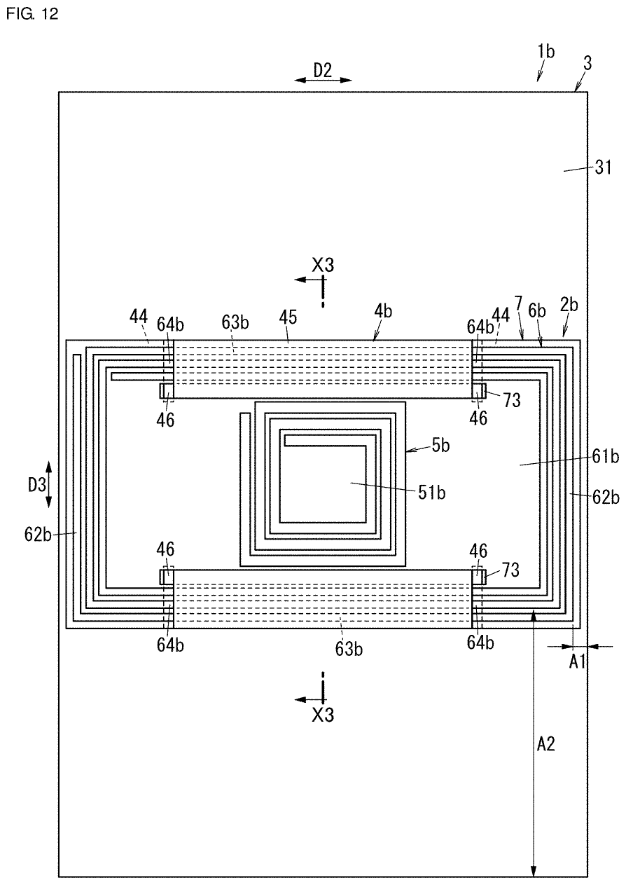

As illustrated in FIG. 12, an antenna device 1b according to a preferred embodiment 3 of the present invention differs from the antenna device 1 according to the preferred embodiment 1 (refer to FIG. 1) in that a first coil antenna 5b and a second coil antenna 6b are provided on a substrate 7 rather than the magnetic body 4 (refer to FIG. 1). Elements that are the same or substantially the same as those of the antenna device 1 according to the preferred embodiment 1 are denoted by the same symbols and description thereof is omitted.

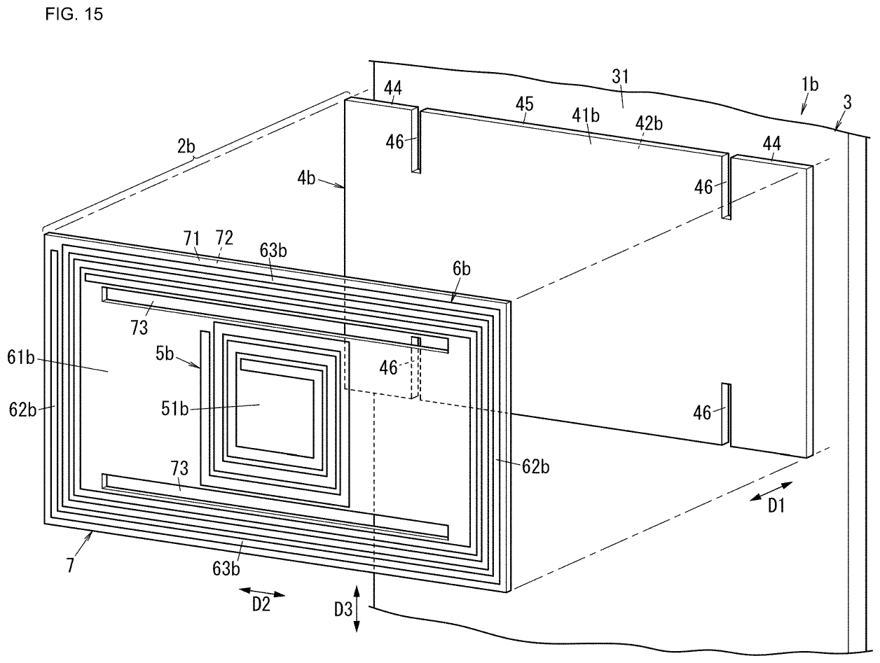

As illustrated in FIGS. 12 to 15, the antenna device 1b according to the preferred embodiment 3 includes an antenna element 2b and a planar conductor 3. The planar conductor 3 of the preferred embodiment 3 has the same or substantially the same shape and function as the planar conductor 3 of the preferred embodiment 1.

The antenna element 2b includes a magnetic body 4b, the first coil antenna 5b, the second coil antenna 6b, and the substrate 7. The antenna element 2b has a rectangular or substantially rectangular shape similarly to the antenna element 2 of the preferred embodiment 1 (refer to FIG. 1).

The substrate 7 preferably has a plate shape or a sheet shape using an electrically insulating material, such as a resin, for example, and includes a first main surface 71 and a second main surface 72. The substrate 7 preferably has a rectangular or substantially rectangular shape in a plan view from the first direction D1. For example, polyimide, polyethylene terephthalate (PET) or a liquid crystal polymer (LCP) may preferably be used as the electrically insulating material used in the substrate 7. The substrate 7 preferably has flexibility.

The substrate 7 has a sufficient size that enables the first coil antenna 5b and the second coil antenna 6b to be provided thereon. The first coil antenna 5b and the second coil antenna 6b are provided on the first main surface 71 of the substrate 7.

The substrate 7 includes a plurality of through holes 73 (two in the illustrated example). The through holes 73 are provided between the first coil antenna 5b and second coil conductor portions 63b of the second coil antenna 6b in the third direction D3. The through holes 73 penetrate between the first main surface 71 and the second main surface 72 in the first direction D1.

The first coil antenna 5b preferably has a square or substantially square annular shape in a plan view from the first direction D1, and has a first opening 51b. The first coil antenna 5b communicates in a first frequency band with a first partner-side coil antenna 92 (refer to FIG. 6), which is a communication partner of the first coil antenna 5b.

The first coil antenna 5b is provided on the first main surface 71 of the substrate 7. In other words, the first coil antenna 5b is closer to the first main surface 71 of the substrate 7 than the second main surface 72 of the substrate 7 in the first direction D1. The first coil antenna 5b differs from the first coil antenna 5 of the preferred embodiment 1 in that the first coil antenna 5b is provided on the substrate 7. However, the first coil antenna 5b is provided on a first main surface 41b side of the magnetic body 4b similarly to the first coil antenna 5 of the preferred embodiment 1.

In more detail, the first coil antenna 5b is provided on the substrate 7 such that the conductor thereof is wound through a plurality of turns around a first axis in a plan view from the first axis direction (first direction D1). The first coil antenna 5b is preferably made of copper, aluminum, or the like, for example, and is provided on the first main surface 71 side of the substrate 7. For example, a copper film or an aluminum film is preferably provided on the first main surface 71 of the substrate 7 by performing etching or printing, for example.

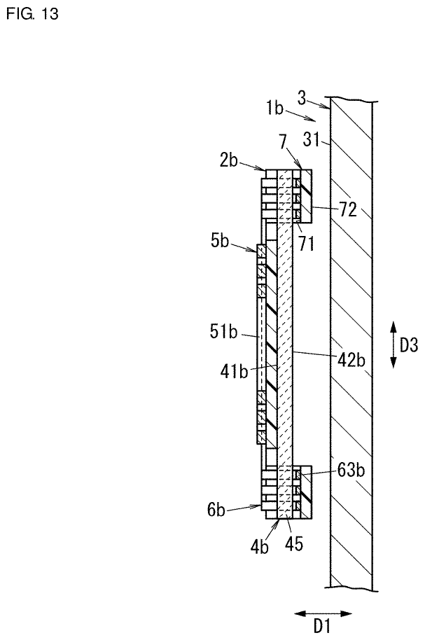

The first coil antenna 5b is provided in a spiral shape around a second axis that extends in the first direction D1. Furthermore, the first coil antenna 5b provided in a spiral shape may be a two-dimensional coil antenna having a shape in which the conductor is wound through a plurality of turns in a spiral shape around a winding axis on a single plane. Alternatively, the first coil antenna 5b provided in a spiral shape may be a three-dimensional coil antenna having a shape in which the conductor is wound through a plurality of turns around a winding axis in a helical shape along the winding axis. FIGS. 12 and 13 illustrate a two-dimensional coil antenna.

The second coil antenna 6b preferably has a rectangular or substantially rectangular annular shape in a plan view from the first direction D1, and includes a second opening 61b. The second coil antenna 6b is provided around the periphery of the first coil antenna 5b on the substrate 7. That is, the second coil antenna 6b is provided outside the outermost periphery of the first coil antenna 5b.

The second coil antenna 6b includes two first coil conductor portions 62b, two second coil conductor portions 63b, and four connection portions 64b. The two first coil conductor portions 62b, the two second coil conductor portions 63b, and the four connection portions 64b are all provided on the first main surface 71 of the substrate 7. In other words, the second coil antenna 6b is arranged so as to be closer to the first main surface of the substrate 7 than the second main surface 72 of the substrate 7 in the first direction D1. The four connection portions 64b are provided between the first coil conductor portions 62b and the second coil conductor portions 63b in the substrate 7. The first coil conductor portions 62b and the second coil conductor portions 63b are not superposed with each other in the first direction D1.

In more detail, the second coil antenna 6b is provided on the substrate 7 such that the conductor thereof is wound through a plurality of turns around a second axis in a plan view from the second axis direction (first direction D1). The second coil antenna 6b is preferably made of copper, aluminum, or the like and is provided on the first main surface 71 side of the substrate 7. For example, a copper film or an aluminum film is preferably provided on the first main surface 71 of the substrate 7 by performing etching or printing, for example.

The second coil antenna 6b is provided in a spiral shape around a second axis that extends in the first direction D1. Furthermore, the second coil antenna 6b provided in a spiral shape may be a two-dimensional coil antenna having a shape in which the conductor is wound through a plurality of turns in a spiral shape around a winding axis on a single plane. Alternatively, the second coil antenna 6b provided in a spiral shape may be a three-dimensional coil antenna having a shape in which the conductor is wound through a plurality of turns around a winding axis in a helical shape along the winding axis. FIGS. 12 and 13 illustrate a two-dimensional coil antenna.

The magnetic body 4b preferably has a rectangular or substantially rectangular plate shape or a rectangular or substantially rectangular sheet shape using a ferromagnetic material, such as ferrite, for example. The magnetic body 4b is preferably made of a sintered ferrite, an amorphous magnetic material, or a magnetic sheet, for example. For example, a Mn—Zn—Fe ferrite or Ni—Zn—Fe ferrite may preferably be used as the ferromagnetic material used in the magnetic body 4b. The magnetic body 4b has higher magnetic permeability than the planar conductor 3 and the protective layer (not illustrated).

The magnetic body 4b includes two first magnetic portions 44 and a second magnetic portion 45. In the preferred embodiment 3, the two first magnetic portions 44 and the second magnetic portion 45 are integrated. The two first magnetic portions 44 and the second magnetic portion 45 are arrayed in the second direction D2 such that the second magnetic portion 45 is positioned between the two first magnetic portions 44 in the second direction D2. The magnetic body 4b includes a plurality of slits (four in the illustrated example). The slits 46 are provided along the third direction D3 at the boundaries between the first magnetic portions 44 and the second magnetic portion 45. In other words, portions of the first magnetic portions 44 and the second magnetic portion 45 are connected to each other and the remaining portions are separated from each other by the slits 46.

Next, a non-limiting example of a method of combining the magnetic body 4b and the substrate 7 as described above will be described. First, the magnetic body 4b is provided on the second main surface 72 side of the substrate 7, the first coil antenna 5b and the second coil antenna 6b having been formed on the first main surface 71 of the substrate 7. Then, in the state where the magnetic body 4b is provided on the second main surface 72 side of the substrate 7, the two end portions of the second magnetic portion 45 in the third direction D3 are provided on the first main surface 71 of the substrate 7 via the through holes 73 of the substrate 7. Thus, the magnetic body 4b is combined with the substrate 7.

In the state where the magnetic body 4b has been combined with the substrate 7, the first coil antenna 5b and the two first coil conductor portions 62b of the second coil antenna 6b are provided on the first main surface 41b side of the magnetic body 4b, and the two second coil conductor portions 63b of the second coil antenna 6b are provided on a second main surface 42b side of the magnetic body 4b. Then, the four connection portions 64b are provided inside the slits 46 of the magnetic body 4b.

As described above, in the antenna device 1b according to the preferred embodiment 3, the magnetic body 4b is inserted into the through holes 73 provided between the first coil antenna 5b and the second coil conductor portions 63b of the second coil antenna 6b. As a result, the first coil antenna 5b and the first coil conductor portions 62b of the second coil antenna 6b are able to be easily provided on the first main surface 41b side of the magnetic body 4b and the second coil conductor portions 63b of the second coil antenna 6b are able to be easily provided on the second main surface 42b side of the magnetic body 4b without directly providing the first coil antenna 5b and the second coil antenna 6b on the magnetic body 4b.

In addition, the magnetic body 4b is not limited to a configuration in which the two first magnetic portions 44 and the second magnetic portion 45 are integrated with each other. The two first magnetic portions 44 and the second magnetic portion 45 may instead be separate bodies. In this case, different materials may be used for the first magnetic portions 44 and the second magnetic portion 45. For example, a material that is suitable for the second frequency band used in communication using the second coil antenna 6 is able to be used as the material of the first magnetic portions 44. Similarly, a material that is suitable for the first frequency band used in communication using the first coil antenna 5b is able to be used as the material of the second magnetic portion 45. Thus, in the preferred embodiment 3, since the first coil antenna 5b and the second coil antenna 6b are provided on the substrate 7 rather than the magnetic body 4b, there is no need to provide the coil antennas directly on the magnetic body 4b and additionally there is no need to provide via conductors that penetrate through the magnetic body 4b.

Furthermore, the antenna device 1b according to the preferred embodiment 3 is used by being mounted in the electronic appliance 8 (refer to FIG. 4) similarly to the antenna device 1 according to preferred embodiment 1.

### Preferred Embodiment 4

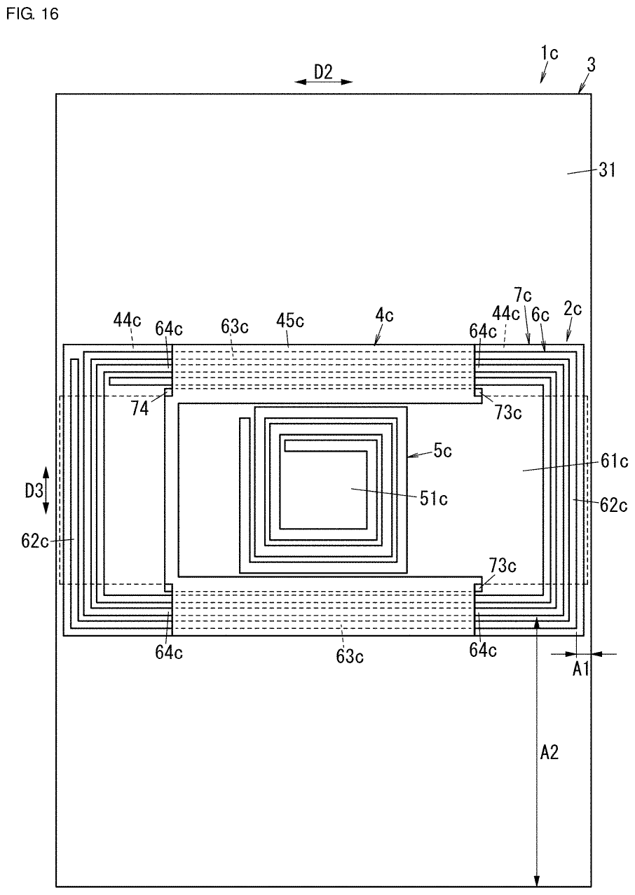

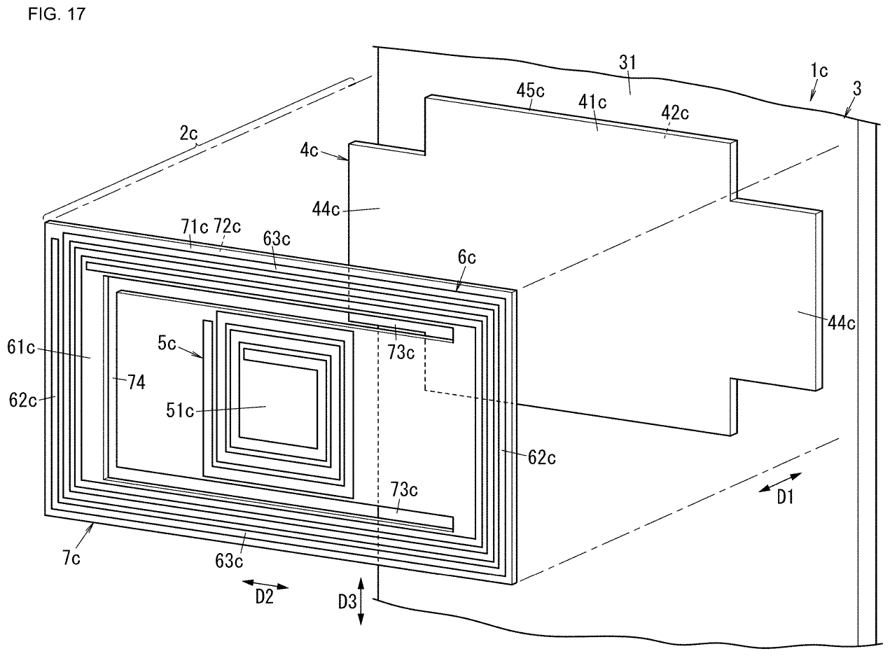

As illustrated in FIGS. 16 and 17, an antenna device 1c according to preferred embodiment 4 of the present invention differs from the antenna device 1b according to the preferred embodiment 3 (refer to FIG. 12) in that a magnetic body 4c has a cross shape. Elements that are the same or substantially the same as those of the antenna device 1b according to the preferred embodiment 3 are denoted by the same symbols and description thereof is omitted.

As illustrated in FIGS. 16 and 17, an antenna device 1c according to the preferred embodiment 4 includes an antenna element 2c and a planar conductor 3. The planar conductor 3 of the preferred embodiment 4 has the same or substantially the same shape and function as the planar conductor 3 of preferred embodiment 3 (refer to FIG. 12).

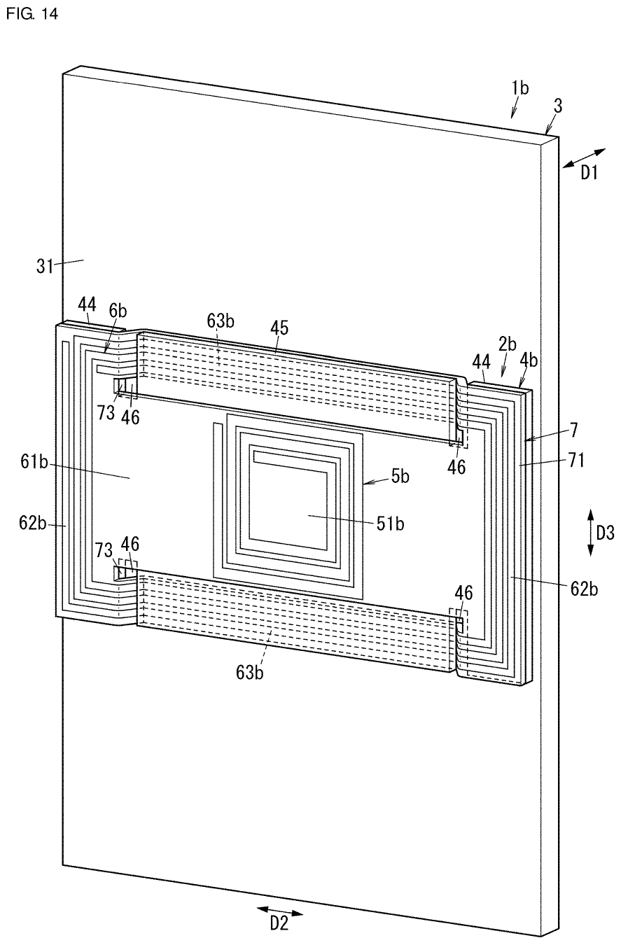

The antenna element 2c includes the magnetic body 4c, a first coil antenna 5c, a second coil antenna 6c, and a substrate 7c. The antenna element 2c preferably has a rectangular or substantially rectangular shape similarly to the antenna element 2b of the preferred embodiment 3 (refer to FIG. 14).

Similarly to the substrate 7 of the preferred embodiment 3 (refer to FIG. 12), the substrate 7c preferably has a plate shape or a sheet shape using an electrically insulating material, such as a resin, for example, and includes a first main surface 71c and a second main surface 72c. The first coil antenna 5c and the second coil antenna 6c are provided on the first main surface 71c of the substrate 7c. The configuration and function of the substrate 7c of the preferred embodiment 4 are the same or substantially the same as those of the substrate 7 of the preferred embodiment 3 and description thereof is omitted.

The substrate 7c includes two through holes 73c and one through hole 74. The through holes 73c are provided between the first coil antenna 5c and the second coil conductor portions 63c of second coil antenna 6c in the third direction D3. The through hole 74 is provided between the first coil antenna 5c and the first coil conductor portions 62c of second coil antenna 6c in the second direction D2. The through holes 73c and 74 penetrate between the first main surface 71c and the second main surface 72c in the first direction D1.

Similarly to the first coil antenna 5b of the preferred embodiment 3 (refer to FIG. 12), the first coil antenna 5c preferably has a square or substantially square annular shape in a plan view from the first direction D1 and includes a first opening 51c. The first coil antenna 5c communicates in a first frequency band with a first partner-side coil antenna 92 (refer to FIG. 6), which is a communication partner of the first coil antenna 5c. The configuration and function of the first coil antenna 5c of preferred embodiment 4 are the same or substantially the same as those of the first coil antenna 5b of preferred embodiment 3 and description thereof is omitted.

Similarly to the second coil antenna 6b of the preferred embodiment 3 (refer to FIG. 12), the second coil antenna 6c preferably has a rectangular or substantially rectangular annular shape in a plan view from the first direction D1 and includes a second opening 61c. The second coil antenna 6c is provided around the periphery of the first coil antenna 5c on the substrate 7c. That is, the second coil antenna 6c is provided outside the outermost periphery of the first coil antenna 5c. The configuration and function of the second coil antenna 6c of the preferred embodiment 4 are the same or substantially the same as those of the second coil antenna 6b of the preferred embodiment 3 and description thereof is omitted.

The second coil antenna 6c includes two first coil conductor portions 62c, two second coil conductor portions 63c, and four connection portions 64c. The two first coil conductor portions 62c, the two second coil conductor portions 63c, and the four connection portions 64c are all provided on the first main surface 71c of the substrate 7c. The configurations and functions of the first coil conductor portions 62c, the second coil conductor portions 63c, and the connection portions 64c of the preferred embodiment 4 are the same or substantially the same as those of the first coil conductor portions 62b, the second coil conductor portions 63b, and the connection portions 64b of the preferred embodiment 3 and description thereof is omitted.

The magnetic body 4c preferably has a rectangular or substantially rectangular plate shape or a rectangular or substantially rectangular sheet shape using a ferromagnetic material, such as ferrite, for example. The magnetic body 4c is preferably made of a sintered ferrite, an amorphous magnetic material, or a magnetic sheet, for example. For example, a Mn—Zn—Fe ferrite or Ni—Zn—Fe ferrite may preferably be used as the ferromagnetic material used in the magnetic body 4c. The magnetic body 4c has higher magnetic permeability than the planar conductor 3 and the protective layer (not illustrated).

The magnetic body 4c includes two first magnetic portions 44c and a second magnetic portion 45c. In the preferred embodiment 4, the two first magnetic portions 44c and the second magnetic portion 45c are integrated. The two first magnetic portions 44c and the second magnetic portion 45c are arrayed in the second direction D2 such that the second magnetic portion 45c is positioned between the two first magnetic portions 44c in the second direction D2. In addition, the second magnetic portion 45c is longer than the first magnetic portions 44c in the third direction D3.

Next, a non-limiting example of a method of combining the magnetic body 4c and the substrate 7c as described above will be described. First, the magnetic body 4c is provided on the first main surface 71c side of the substrate 7c. In the state where the magnetic body 4c has been provided on the first main surface 71c side of the substrate 7c, portion of the magnetic body 4c is passed through the through hole 74 and the through holes 73c. In more detail, one first magnetic portion 44c and a center portion of the second magnetic portion 45c of the magnetic body 4c are passed through the through hole 74 and the through holes 73c. Then, the remaining first magnetic portion 44c of the magnetic body 4c is passed through the through hole 74. In this way, both end portions of the second magnetic portion 45c are provided on the first main surface 71c side of the substrate 7c and the remaining portions of the magnetic body 4c other than both end portions of the second magnetic portion 45c are provided on the second main surface 72c side of the substrate 7c. Thus, the magnetic body 4c is combined with the substrate 7c.

In the state where the magnetic body 4c has been combined with the substrate 7c, the first coil antenna 5c and the two first coil conductor portions 62c of the second coil antenna 6c are provided on the first main surface 41c side of the magnetic body 4c and the two second coil conductor portions 63c of the second coil antenna 6c are provided on the second main surface 42c side of the magnetic body 4c.

As described above, in the antenna device 1c according to the preferred embodiment 4, the magnetic body 4c is inserted into the through holes 73c and the through hole 74, which are provided between the first coil antenna 5c and the second coil conductor portions 63c of the second coil antenna 6c. Thus, the first coil antenna 5c and the first coil conductor portions 62c of the second coil antenna 6c are able to be easily provided on the first main surface 41c side of the magnetic body 4c and the second coil conductor portions 63c of the second coil antenna 6c are able to be easily provided on the second main surface 42c side of the magnetic body 4c without directly providing the first coil antenna 5c and the second coil antenna 6c on the magnetic body 4c.

The magnetic body 4c is not limited to having a configuration in which the two first magnetic portions 44c and a second magnetic portion 45c are integrated with each other. The two first magnetic portions 44c and the second magnetic portion 45c may be separate bodies. In this case, different materials are able to be used for the first magnetic portions 44c and the second magnetic portion 45c. For example, a material that is suitable for the second frequency band used in communication using the second coil antenna 6c is able to be used as the material of the first magnetic portions 44c. Similarly, a material that is suitable for the first frequency band used in communication using the first coil antenna 5c is able to be used as the material of the second magnetic portion 45c.

Furthermore, the antenna device 1c according to the preferred embodiment 4 is used by being mounted in the electronic appliance 8 (refer to FIG. 4) similarly to the antenna device 1 according to the preferred embodiment 1.

The above-described preferred embodiments and modifications thereof are merely examples of various preferred embodiments and modifications of the present invention. In addition, as long as the advantages of the present invention are achieved, the preferred embodiments and modifications may be changed in various ways in accordance with the design and so forth.

The following preferred embodiments are disclosed based on the above-described preferred embodiments and modifications thereof.

An antenna device (1; 1a; 1b; 1c) according to a preferred embodiment of the present invention includes a magnetic body (4; 4b; 4c); a first coil antenna (5; 5a; 5b; 5c); and a second coil antenna (6; 6b; 6c). The magnetic body (4; 4b; 4c) includes a first main surface (41; 41b; 41c) and a second main surface (42; 42b; 42c). The second main surface (42; 42b; 42c) faces the first main surface (41; 41b; 41c). The first coil antenna (5; 5a; 5b; 5c) includes a first opening (51; 51a; 51b; 51c) and is provided on the first main surface (41; 41b; 41c) side of the magnetic body (4; 4b; 4c). The second coil antenna (6; 6b; 6c) includes a second opening (61; 61b; 61c). The first opening (51; 51a; 51b; 51c) is partially superposed with the second opening (61; 61b; 61c) in a plan view of the first main surface (41; 41b; 41c) of the magnetic body (4; 4b; 4c). The second coil antenna (6; 6b; 6c) includes first coil conductor portions (62; 62b; 62c) and second coil conductor portions (63; 63b; 63c). The first coil conductor portions (62; 62b; 62c) are provided on the first main surface (41; 41b; 41c) side of the magnetic body (4; 4b; 4c). The second coil conductor portions (63; 63b; 63c) are provided on the second main surface (42; 42b; 42c) side of the magnetic body (4; 4b; 4c). The second coil conductor portions (63; 63b; 63c) are closer to the first coil antenna (5; 5a; 5b; 5c) than the first coil conductor portions (62; 62b; 62c).

In an antenna device (1; 1a; 1b; 1c) according to a preferred embodiment of the present invention, the first coil antenna (5; 5a; 5b; 5c) and the first coil conductor portions (62; 62b; 62c) of the second coil antenna (6; 6b; 6c) are arranged on the first main surface (41; 41b; 41c) side of the magnetic body (4; 4b; 4c), and the second coil conductor portions (63; 63b; 63c) of the second coil antenna (6; 6b; 6c), which are closer to the first coil antenna (5; 5a; 5b; 5c) than the first coil conductor portions (62; 62b; 62c) of the second coil antenna (6; 6b; 6c), are provided on the second main surface (42; 42b; 42c) side of the magnetic body (4; 4b; 4c). Due to this configuration, interference caused by the second coil antenna (6; 6b; 6c) in communication between the first coil antenna (5; 5a; 5b; 5c) and a first partner-side coil antenna (92) is able to be reduced, and therefore the degree of coupling between the first coil antenna (5; 5a; 5b; 5c) and the first partner-side coil antenna (92) is able to be improved. Furthermore, interference caused by the first coil antenna (5; 5a; 5b; 5c) in communication between the second coil antenna (6; 6b; 6c) and a second partner-side coil antenna (94) is also able to be reduced, and therefore the degree of coupling between the second coil antenna (6; 6b; 6c) and the second partner-side coil antenna (94) is also able to be improved.

An antenna device (1; 1a; 1b; 1c) according to a preferred embodiment of the present invention further includes a planar conductor (3) in addition to the configuration of the first mode. The planar conductor (3) is provided on a second main surface (42; 42b; 42c) side of the magnetic body (4; 4b; 4c) so as to face the magnetic body (4; 4b; 4c).

In an antenna device (1; 1a; 1b; 1c) according to a preferred embodiment of the present invention, the planar conductor (3) is provided on the second main surface (42; 42b; 42c) side of the magnetic body (4; 4b; 4c). It is difficult for magnetic flux to flow through the planar conductor (3), and therefore magnetic fluxes (φ1, φ21, φ22) flowing in a direction perpendicular or substantially perpendicular to the first main surface (41; 41b; 41c) of the magnetic body (4; 4b; 4c) are able to be easily changed to flow in a direction that intersects that direction. As a result, collection of magnetism is able to be improved.

In an antenna device (1; 1a; 1b; 1c) according to a preferred embodiment of the present invention, the first coil conductor portions (62; 62b; 62c) are closer to an outer edge of the planar conductor (3) than the second coil conductor portions (63; 63b; 63c) in the configuration of the second mode.

In an antenna device (1; 1a; 1b; 1c) according to a preferred embodiment of the present invention, the first coil conductor portions (62; 62b; 62c) are closer to an outer edge of the planar conductor (3) than the second coil conductor portions (63; 63b; 63c). Due to this configuration, magnetic flux (φ21) that flows through the second opening (61; 61b; 61c) of the second coil antenna (6; 6b; 6c) from the first main surface (41; 41b; 41c) side of the magnetic body (4; 4b; 4c) is able to flow inside the magnetic body (4; 4b; 4c) toward the sides where the first coil conductor portions (62; 62b; 62c) are provided and return to the second partner-side coil antenna (94). Furthermore, the magnetic flux (T22) flowing along the planar conductor 3 is able to enter the inside of the magnetic body (4; 4b; 4c) from the portions where the second coil conductor portions (63; 63b; 63c) are provided, flow inside the magnetic body (4; 4b; 4c) toward the sides where the first coil conductor portions (62; 62b; 62c) are provided, and return to the second partner-side coil antenna (94).

An antenna device (1b; 1c) according to a preferred embodiment of the present invention further includes a substrate (7; 7c). The first coil antenna (5b; 5c) and the second coil antenna (6b; 6c) are provided on one main surface of the substrate (7, 7c). The substrate (7, 7c) includes through holes (73; 73c). The through holes (73; 73) are provided between the first coil antenna (5b; 5c) and the second coil conductor portions (63b; 63c) of the second coil antenna (6b; 6c). The magnetic body (4b; 4c) is inserted into the through holes (73; 73c) of the substrate (7, 7c).

In an antenna device (1b; 1c) according to a preferred embodiment of the present invention, the magnetic body (4b; 4c) is inserted into the through holes (73; 73c) provided between the first coil antenna (5b; 5c) and the second coil conductor portions (63b; 63c) of the second coil antenna (6b; 6c). Thus, the first coil antenna (5b; 5c) and the first coil conductor portions (62b; 62c) of the second coil antenna (6b; 6c) are able to be easily provided on the first main surface (41b; 41c) side of the magnetic body (4b; 4c) and the second coil conductor portions (63b; 63c) of the second coil antenna (6b; 6c) are able to be easily provided on the second main surface (42b; 42c) side of the magnetic body (4b; 4c) without directly providing the first coil antenna (5b; 5c) and the second coil antenna (6b; 6c) on the magnetic body (4b; 4c).

An electronic appliance (8) according to a fifth mode includes the antenna device (1; 1a; 1b; 1c) according to any one of the first to fourth modes and a controller (81). The controller (81) controls the antenna device (1; 1a; 1b; 1c).

In the electronic appliance (8) according to a preferred embodiment of the present invention, the first coil antenna (5; 5a; 5b; 5c) and the first coil conductor portions (62; 62b; 62c) of the second coil antenna (6; 6b; 6c) are provided on the first main surface (41; 41b; 41c) side of the magnetic body (4; 4b; 4c), and the second coil conductor portions (63; 63b; 63c) of the second coil antenna (6; 6b; 6c), which are closer to the first coil antenna (5; 5a; 5b; 5c) than the first coil conductor portions (62; 62b; 62c) of the second coil antenna (6; 6b; 6c), are provided on the second main surface (42; 42b; 42c) side of the magnetic body (4; 4b; 4c) in the antenna device (1; 1a; 1b; 1c). Due to this configuration, interference caused by the second coil antenna (6; 6b; 6c) in communication between the first coil antenna (5; 5a; 5b; 5c) and a first partner-side coil antenna (92) is able to be reduced, and therefore the degree of coupling between the first coil antenna (5; 5a; 5b; 5c) and the first partner-side coil antenna (92) is able to be improved. Furthermore, interference caused by the first coil antenna (5; 5a; 5b; 5c) in communication between the second coil antenna (6; 6b; 6c) and a second partner-side coil antenna (94) is also able to be reduced, and therefore the degree of coupling between the second coil antenna (6; 6b; 6c) and the second partner-side coil antenna (94) is also able to be improved.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An antenna device comprising:
a magnetic body including a first main surface and a second main surface that faces the first main surface;
a first coil antenna including a first opening and provided on a first main surface side of the magnetic body; and
a second coil antenna including a second opening; wherein
the first opening is partially superposed with the second opening in a plan view of the first main surface of the magnetic body;
the second coil antenna includes:
a first coil conductor portion provided on the first main surface side of the magnetic body; and
a second coil conductor portion provided on a second main surface side of the magnetic body; and
the second coil conductor portion is closer to the first coil antenna than the first coil conductor portion.

2. The antenna device according to claim 1, further comprising a planar conductor provided on the second main surface side of the magnetic body and facing the magnetic body.

3. The antenna device according to claim 2, wherein the first coil conductor portion is closer to an outer edge of the planar conductor than the second coil conductor portion.

4. The antenna device according to claim 1, further comprising:
a substrate including one main surface on which the first coil antenna and the second coil antenna are provided and including a through hole provided between the first coil antenna and the second coil conductor portion of the second coil antenna; wherein
the magnetic body is inserted into the through hole of the substrate.

5. The antenna device according to claim 1, wherein the first coil antenna is structured to perform wireless charging.

6. The antenna device according to claim 1, wherein the second coil antenna is structured to perform near field wireless communication.

7. The antenna device according to claim 2, wherein the planar conductor is made of aluminum, stainless steel, or copper.

8. The antenna device according to claim 2, wherein the planar conductor is a metal case.

9. The antenna device according to claim 2, wherein the planar conductor is superposed with the magnetic body.

10. The antenna device according to claim 1, wherein the magnetic body is made of a sintered ferrite or an amorphous magnetic material.

11. An electronic appliance comprising:
the antenna device according to claim 1; and
a controller that controls the antenna device.

12. The electronic appliance according to claim 11, further comprising a planar conductor provided on the second main surface side of the magnetic body and facing the magnetic body.

13. The electronic appliance according to claim 12, wherein the first coil conductor portion is closer to an outer edge of the planar conductor than the second coil conductor portion.

14. The electronic appliance according to claim 11, further comprising:
a substrate including one main surface on which the first coil antenna and the second coil antenna are provided and including a through hole provided between the first coil antenna and the second coil conductor portion of the second coil antenna; wherein
the magnetic body is inserted into the through hole of the substrate.

15. The electronic appliance according to claim 11, wherein the first coil antenna is structured to perform wireless charging.

16. The electronic appliance according to claim 11, wherein the second coil antenna is structured to perform near field wireless communication.

17. The electronic appliance according to claim 12, wherein the planar conductor is made of aluminum, stainless steel, or copper.

18. The electronic appliance according to claim 12, wherein the planar conductor is a metal case.

19. The electronic appliance according to claim 12, wherein the planar conductor is superposed with the magnetic body.

20. The electronic appliance according to claim 11, wherein the magnetic body is made of a sintered ferrite or an amorphous magnetic material.
